(19) United States
(12) Patent Application Publication
(10) Pub. No.: US 2025/0382997 A1
(43) Pub. Date: Dec. 18, 2025

(54) BRAKE FRICTION MEMBER AND TRANSFER FILM FORMATION METHOD USING BRAKE FRICTION MEMBER

(71) Applicant: SUBARU CORPORATION, Tokyo (JP)

(72) Inventors: Yujiro KONDO, Tokyo (JP); Tomonori IMAIZUMI, Tokyo (JP); Takahisa ISHIZAKA, Tokyo (JP)

(73) Assignee: SUBARU CORPORATION, Tokyo (JP)

(21) Appl. No.: 19/240,722

(22) Filed: Jun. 17, 2025

(30) Foreign Application Priority Data
Jun. 18, 2024 (JP) 2024-097976

(51) Int. Cl. F16D 65/095; B32B 7/027; B32B 9/04; F16D 69/00; F16D 69/02

(52) U.S. Cl. CPC F16D 65/095; B32B 7/027; B32B 9/045; F16D 69/025; B32B 2605/00; F16D 2069/001; F16D 2069/005; F16D 2200/0034; F16D 2200/0078

(57) ABSTRACT

A brake friction member includes a friction base material and a transfer film material. The friction base material is stacked on a back plate. The transfer film material is stacked on the friction base material and faces an opposing member. The transfer film material is made of a composition obtained by mixing an organic filler in an ultralow melting point resin component.

### CROSS-REFERENCE TO RELATED APPLICATIONS

The present application claims priority from Japanese Patent Application No. 2024-097976 filed on Jun. 18, 2024, the entire contents of which are hereby incorporated by reference.

### BACKGROUND OF THE INVENTION

### Field of the Invention

The disclosure relates to a brake friction member and a transfer film formation method using a brake friction member.

### Description of Background Art

Japanese Unexamined Patent Application Publication (JP-A) No. 2023-47688 describes a technique in which a component of a brake friction member enables stable forming of a transfer film. The entire contents of this publication are incorporated herein by reference.

### SUMMARY OF THE INVENTION

According to one aspect of the present invention, a brake friction member includes a friction base material stacked on a back plate, and a transfer film material stacked on the friction base material and configured to face an opposing member. The transfer film material includes a composition obtained by mixing an organic filler in an ultralow melting point resin component.

According to another aspect of the present invention, a transfer film formation method using a brake friction member includes placing a wheel of a vehicle mounted with a brake device including the brake friction member described above on a roller installed at a fixing base for a vehicle running test, driving the vehicle while restraining the vehicle by the fixing base, operating the brake device to continuously exert a low-load braking for a predetermined time by pressing the transfer film material of the brake friction member against the opposing member rotating together with the wheel, and forming a transfer film on a friction surface of the opposing member by transferring the transfer film material to the friction surface using heat generated at a friction interface between the transfer film material and the opposing member.

According to another aspect of the present invention, a transfer film formation method using a brake friction member includes placing, on a roller installed at a fixing base for a vehicle running test, a wheel of a vehicle mounted with a brake device including a brake friction member having a transfer film layer including two or more layers such that a melting point of the ultralow melting point resin component is set to become lower from a layer on a friction base material side toward an outermost layer, driving the vehicle while restraining the vehicle by the fixing base, operating the brake device to continuously exert a low-load braking for a predetermined time by pressing the transfer film material of the brake friction member against the opposing member rotating together with the wheel, and forming a transfer film on a friction surface of the opposing member by transferring at least the transfer film layer of the outermost layer to the friction surface using heat generated at a friction interface between the transfer film material and the opposing member.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic cross-sectional view of a disc brake device according to an embodiment;

FIG. 2 is a cross-sectional view of a brake pad according to the embodiment; and

FIG. 3 is a cross-sectional view of a brake pad according to an embodiment.

### DETAILED DESCRIPTION OF THE EMBODIMENTS

Embodiments will now be described with reference to the accompanying drawings, wherein like reference numerals designate corresponding or identical elements throughout the various drawings.

Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis.

### First Embodiment

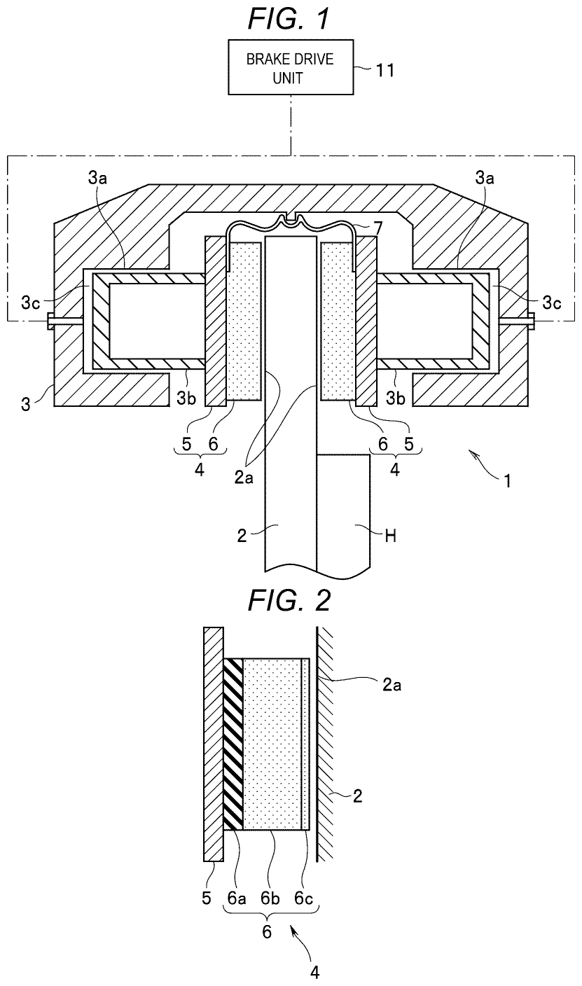

FIG. 1 and FIG. 2 illustrate a first embodiment of the disclosure. A brake device 1 illustrated in FIG. 1 is provided at four wheels or drive wheels of a vehicle. The vehicle used in the present embodiment is an electric vehicle. The electric vehicle includes a regenerative cooperative brake as a brake system.

The brake device 1 is an opposed piston type. The brake device 1 includes a disc rotor 2 as an opposing member. The disc rotor 2 is fixed to a hub H of each axle and is rotated together with the axle (wheel). The brake device 1 also includes a caliper 3. The caliper 3 is fixed to a vehicle body of the electric vehicle. The caliper 3 has a substantially groove-like cross-section striding across the disc rotor. A cylinder 3a is formed at each surface of the caliper 3 facing the disc rotor 2. A piston 3b is installed in the cylinder 3a.

Further, a brake pad 4 is provided in front of the piston 3b. The brake pad 4 includes a back plate 5 and a brake friction member 6. The back surface of the back plate 5 is fixed to the piston 3b. The back surface of the brake friction member 6 is fixed to the front surface of the back plate 5. The front surface of the brake friction member 6 faces a friction surface 2a provided at both sides of the disc rotor 2. A brake cylinder chamber 3c closed by the cylinder 3a and the piston 3b is formed.

The brake device 1 also includes a brake drive unit 11. The brake drive unit 11 supplies and releases a brake hydraulic pressure to and from the brake cylinder chamber 3c. When the brake drive unit 11 supplies a brake hydraulic pressure to the brake cylinder chamber 3c, the piston 3b pushes the brake pad 4 in a direction toward the friction surface 2a. Then, the brake friction members 6 of the brake pads 4 press and sandwich the friction surfaces 2a provided at both sides of the disc rotor 2. When the brake friction members 6 press and sandwich the friction surfaces 2a, the friction surfaces 2a slides on the brake friction members 6, and the friction at this time generates a braking force to the electric vehicle.

Both the brake pads 4 are always biased in a direction separating from each other by a return spring 7. When the brake drive unit 11 releases the brake hydraulic pressure supplied to the brake cylinder chamber 3c, both the brake pads 4 are retracted in the direction separating from each other by the biasing force of the return spring 7. As a result, the brake friction members 6 face the friction surfaces 2a of the disc rotor 2 with a predetermined brake clearance to the friction surfaces 2a, and thus the braking force is released.

As illustrated in FIG. 2, the brake friction member 6 has a three-layer structure. That is, the brake friction member 6 includes a double-layer material (underlayer) 6a, a friction base material 6b, and a transfer film material 6c from the back plate 5 side.

The double-layer material 6a is a vibration absorbing layer coupling the back plate 5 and the friction base material 6b. The double-layer material 6a reduces a brake noise during braking. The friction base material 6b is directly pressed against and slides on the friction surface 2a of the disc rotor 2 during braking, thereby generating a braking force to the electric vehicle.

When pressed against the friction surface 2a, the transfer film material 6c is transferred to the friction surface 2a by using heat generated at a friction interface. As a result, a transfer film is formed on the friction surface 2a.

The transfer film material 6c is made of a composition obtained by mixing a film forming organic filler in an ultralow melting point resin component having a low melting point. Examples of the ultralow melting point resin component include ultralow melting point phenol resin and cashew particles. The film forming organic filler is, for example, titanate.

The transfer film material 6c is transferred to the friction surface 2a in a vehicle running test process set in a production line. In the vehicle running test, the wheels of the electric vehicle are placed on rollers provided at a fixing base and various measurements are performed by causing the electric vehicle in a state of being restrained to drive (travel).

For the brake device 1 having the above-described configuration for the electric vehicle, a method of forming a transfer film by transferring the transfer film material 6c of the brake friction member 6 to the friction surface 2a of the disc rotor 2 will be described.

The formation of the transfer film is performed in the production line before shipment. The vehicle running test process is incorporated in the production line. A vehicle running test device is installed in the vehicle running test process. First, an operator places the respective wheels of the electric vehicle assembled as specified on rollers provided at a fixing base of the vehicle running test device. Next, the operator fixes the electric vehicle to the fixing base. Subsequently, the operator causes the electric vehicle to drive (travel). The wheels of the electric vehicle rotate on the rollers.

The operator operates a control device or the operator presses a brake pedal to operate the brake drive unit 11, thereby supplying, to the cylinder 3a provided at the caliper 3 of the electric vehicle, a brake hydraulic pressure in such a degree that light-load braking is caused. Then, the transfer film material 6c of the brake friction member 6 is pressed against the friction surface 2a of the disc rotor 2. As a result, the transfer film material 6c of the brake friction member 6 slides on the friction surface 2a of the disc rotor 2, thereby causing the light-load braking.

The electric vehicle maintains a state in which the light-load braking is caused by the brake device 1, for a predetermined time. Then, heat is generated at the friction interface between the transfer film material 6c of the brake friction member 6 and the friction surface 2a of the disc rotor 2. The transfer film material 6c is an ultralow melting point phenol resin composition. Thus, by maintaining the light-load braking for the predetermined time, heat generated at the friction interface can be used to transfer the transfer film material 6c to the friction surface 2a of the disc rotor 2. Consequently, the transfer film is formed on the friction surface 2a. Since the transfer of the transfer film material 6c is performed in the vehicle running test process, the work efficiency is high.

As a result, the transfer film has already been formed on the friction surface 2a of the disc rotor 2 before the shipment of the electric vehicle. Thus, even when a driver operates the electric vehicle and activates the regenerative cooperative brake immediately after the delivery of the electric vehicle, a stable braking force can be obtained. Since the braking force is stable, the driver can stop the electric vehicle with a braking distance intended by the driver.

Since the formation of the transfer film by the friction base material 6b when the regenerative cooperative brake is operated is the same as that in the related art, the description thereof is omitted.

### Second Embodiment

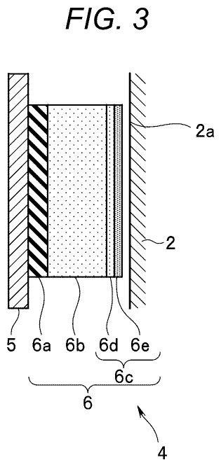

FIG. 3 illustrates a second embodiment of the disclosure. In the present embodiment, the transfer film material 6c has a two-layer structure. The components common to the first embodiment are denoted by the same reference signs and the description thereof is omitted or simplified.

The transfer film material 6c includes a first transfer film layer 6d on the friction base material 6b side and a second transfer film layer 6e which is the outermost layer. The second transfer film layer 6e contains a resin component having a lower melting point than that contained in the first transfer film layer 6d.

the first transfer film layer 6d. For example, the first transfer film layer 6d is an ultralow melting point phenol resin composition. The ultralow melting point phenol resin composition is obtained by mixing a film forming organic filler in ultralow melting point phenol resin. The film forming organic filler is, for example, titanate.

The second transfer film layer 6e is a composition obtained by mixing an organic filler, which is spread at a lower temperature than the ultralow melting point phenol resin, in fine titanate. The organic filler is, for example, a rubber filler.

In the present embodiment, similar to the first embodiment, a light-load braking is caused by operating the brake device 1 while the electric vehicle is caused to drive (travel) on the vehicle running test device. Then, the second transfer film layer 6e of the transfer film material 6c is pressed against the friction surface 2a of the disc rotor 2.

The second transfer film layer 6e is a composition obtained by mixing an organic filler, which is spread at a lower temperature than the ultralow melting point phenol resin, in fine titanate. Thus, heat generated at the friction interface during the light-load braking can be used to transfer the second transfer film layer 6e to the friction surface 2a of the disc rotor 2 in an early stage.

As a result, the transfer film can be securely formed on the friction surface 2a of the disc rotor 2 by transferring the entire second transfer film layer 6e during the vehicle running test process. Then, in the vehicle running test process, after the entire second transfer film layer 6e is transferred, the first transfer film layer 6d is transferred to the friction surface 2a of the disc rotor 2.

The transfer film has already been formed by the entire second transfer film layer be on the friction surface 2a of the disc rotor 2 before the shipment of the electric vehicle. Thus, even when the first transfer film layer 6d slightly remains on the brake friction member 6 side at the shipment of the electric vehicle, the braking performance of the brake device 1 does not become unstable.

The disclosure is not limited to the above-described embodiments, and for example, the above-described embodiments are applicable to vehicles other than an electric vehicle.

The transfer film material 6c may have a structure with three or more layers. In that case, the melting point of the ultralow melting point resin component is set to become lower from the transfer film layer on the friction base material 6b side toward the transfer film layer of the outermost layer. As a result, the formation of the transfer film on the friction surface 2a of the disc rotor 2 can be more securely performed before the shipment of the vehicle.

The brake friction member 6 can be applied, not only to the brake pad 4 of the brake device 1, but to a brake shoe of a drum brake. In that case, the opposing member is a brake drum. The brake friction member 6 can also be applied to the brake pad 4 or a brake shoe which is a replacement part.

According to the disclosure, since the transfer film material, which is stacked on the friction base material on the back plate and faces the opposing member, is made of a composition obtained by mixing an organic filler in an ultralow melting point resin component, a sufficient transfer film can be formed immediately after the delivery of a vehicle even when the vehicle uses a regenerative cooperative brake.

As a brake device mounted on a vehicle such as an automobile, a disc brake and a drum brake are known. A brake pad of a disc brake and a brake shoe of a drum brake are provided with a friction member (brake friction member). A braking force is generated by friction when the brake friction member is pressed against and caused to slide on a disc rotor or a brake drum which is an opposing member.

In a latest brake device, when a brake friction member is pressed against and caused to slide on an opposing member (a disc rotor or a brake drum), a thin transfer film is formed on a friction surface of the opposing member by a component of the brake friction member. The transfer film stabilizes the effect of braking at a high temperature and reduces the wear of the brake friction member.

The transfer film is formed by utilizing heat generated at a friction interface during braking. Electric vehicles such as BEV (battery electric vehicles), PHEV (plug-in hybrid electric vehicles), and HEV (hybrid electric vehicles) reduce their speed by a regenerative cooperative brake.

In a vehicle using a regenerative cooperative brake, the braking force by a brake friction member is lighter load than in a vehicle in which a regenerative cooperation brake is not used. Therefore, the amount of heat generated at a friction interface between the brake friction member and an opposing member is small and a transfer film is less likely to be formed.

For example, Japanese Unexamined Patent Application Publication (JP-A) No. 2023-47688 describes a technique in which a component of a brake friction member is improved to enable stable forming of a transfer film even by braking using a regenerative cooperative brake that generates a small amount of heat.

A vehicle travels little on a road surface before shipment. Thus, almost no transfer film is formed on a friction surface of an opposing member (a disc rotor or a brake drum) that faces a brake friction member. The technique described in JP-A No. 2023-47688 is a technique for stably forming a transfer film during travel.

Therefore, even with the technique described in JP-A No. 2023-47688, a relatively long time is taken to form a sufficient transfer film on an opposing member of a brake device provided in a vehicle using a regenerative cooperative brake immediately after delivery.

Until a sufficient transfer film is formed on the opposing member in the vehicle using the regenerative cooperative brake, a braking force is not stabilized and a braking distance is relatively long. As a result, a driver has a feeling of discomfort. Further, a delay in forming the transfer film causes unstableness of friction and generation of rust, leading to a brake noise or juddering.

It is desirable to provide a brake friction member and a transfer film formation method using the brake friction member capable of forming a sufficient transfer film immediately after delivery of a vehicle even when the vehicle uses a regenerative cooperative brake.

An aspect of the disclosure provides a brake friction member. The brake friction member includes a friction base material and a transfer film material. The friction base material is stacked on a back plate. The transfer film material is stacked on the friction base material and faces an opposing member. The transfer film material is made of a composition obtained by mixing an organic filler in an ultralow melting point resin component.

An aspect of the disclosure provides a transfer film formation method using a brake friction member. The transfer film formation method includes: placing a wheel of a vehicle mounted with a brake device including the above-described brake friction member on a roller installed at a fixing base for a vehicle running test; driving the vehicle while restraining the vehicle by the fixing base; operating the brake device to continuously exert a low-load braking for a predetermined time by pressing the transfer film material of the brake friction member against the opposing member rotating together with the wheel; and forming a transfer film on a friction surface of the opposing member by transferring the transfer film material to the friction surface using heat generated at a friction interface between the transfer film material and the opposing member.

An aspect of the disclosure provides a transfer film formation method. The transfer film formation method includes: placing, on a roller installed at a fixing base for a vehicle running test, a wheel of a vehicle mounted with a brake device including the brake friction member which is provided with a transfer film material having a structure with two or more layers; driving the vehicle while restraining the vehicle by the fixing base; operating the brake device to continuously exert a low load braking for a predetermined time by pressing the transfer film material of the brake friction member against an opposing member rotating together with the wheel; and forming a transfer film on a friction surface of the opposing member by transferring a transfer film layer of at least an outermost layer to the friction surface using heat generated at a friction interface between the transfer film material and the opposing member.

Obviously, numerous modifications and variations of the present invention are possible in light of the above teachings. It is therefore to be understood that within the scope of the appended claims, the invention may be practiced otherwise than as specifically described herein.

1. A brake friction member, comprising:
a friction base material stacked on a back plate; and
a transfer film material stacked on the friction base material and configured to face an opposing member,
wherein the transfer film material comprises a composition obtained by mixing an organic filler in an ultralow melting point resin component.

2. The brake friction member according to claim 1, wherein the transfer film material has a transfer film layer comprising a plurality of layers such that a melting point of the ultralow melting point resin component is set to become lower from a layer on a friction base material side toward an outermost layer.

3. The brake friction member according to claim 1, wherein the transfer film material has a two-layer structure comprising a first transfer film layer on a friction base material side and a second transfer film layer forming an outermost layer facing the opposing member, the first transfer film layer comprises a composition including an ultralow melting point resin component having a low melting point, and the second transfer film layer comprises a composition including an organic filler spread at a lower temperature than the ultralow melting point resin component of the first transfer film layer.

4. A transfer film formation method using a brake friction member, comprising:
placing a wheel of a vehicle mounted with a brake device comprising the brake friction member of claim 1 on a roller installed at a fixing base for a vehicle running test;
driving the vehicle while restraining the vehicle by the fixing base;
operating the brake device to continuously exert a low-load braking for a predetermined time by pressing the transfer film material of the brake friction member against the opposing member rotating together with the wheel; and
forming a transfer film on a friction surface of the opposing member by transferring the transfer film material to the friction surface using heat generated at a friction interface between the transfer film material and the opposing member.

5. A transfer film formation method using a brake friction member, comprising:
placing a wheel of a vehicle mounted with a brake device comprising the brake friction member of claim 2 on a roller installed at a fixing base for a vehicle running test;
driving the vehicle while restraining the vehicle by the fixing base;
operating the brake device to continuously exert a low-load braking for a predetermined time by pressing the transfer film material of the brake friction member against the opposing member rotating together with the wheel; and
forming a transfer film on a friction surface of the opposing member by transferring at least the transfer film layer of the outermost layer to the friction surface using heat generated at a friction interface between the transfer film material and the opposing member.

6. A transfer film formation method using a brake friction member, comprising:
placing a wheel of a vehicle mounted with a brake device comprising the brake friction member of claim 3 on a roller installed at a fixing base for a vehicle running test;
driving the vehicle while restraining the vehicle by the fixing base;
operating the brake device to continuously exert a low-load braking for a predetermined time by pressing the transfer film material of the brake friction member against the opposing member rotating together with the wheel; and
forming a transfer film on a friction surface of the opposing member by transferring at least the transfer film layer of the outermost layer to the friction surface using heat generated at a friction interface between the transfer film material and the opposing member.
